(19) United States
(12) Patent Application Publication
(10) Pub. No.: US 2018/0174146 A1
(43) Pub. Date: Jun. 21, 2018

(54) SITUATIONAL ACCESS OVERRIDE

(71) Applicants: Parveen Bansal, Foster City, CA (US); Aparna Krishnan Girish, Foster City, CA (US); Madhuri Chandoor, Foster City, CA (US)

(72) Inventors: Parveen Bansal, Foster City, CA (US); Aparna Krishnan Girish, Foster City, CA (US); Madhuri Chandoor, Foster City, CA (US)

(21) Appl. No.: 15/380,407

(22) Filed: Dec. 15, 2016

(51) Int. Cl. G06Q 20/40

(52) U.S. Cl. CPC G06Q 20/4016; G06Q 20/40145

(57) ABSTRACT

One or more sensors are used to evaluate whether a user of a financial instrument is under duress by evaluating information collected about the user at the time of a transaction. If one or more stress indicators are above a predetermined threshold level, full access to the financial instrument may be disabled. Transaction risk rules may be increased, transaction amounts may be limited, or transactions may be blocked entirely if full access is disabled.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Often, the goal of a mugger or kidnapper is to force a person to make a financial transaction benefitting the bad actor. Cooperating with the bad actor can lead to a significant theft of funds. Not cooperating with the bad actor may bring physical harm.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

Stress levels may be monitored when a person is using a financial instrument and access to the financial instrument may be limited or denied when the stress levels exceed predetermined threshold levels, according to predetermined contingent actions. One or more sensors for biometric monitoring may be embedded in the person's fitness tracker, a smart device in the person's possession, or a third party machine with which the person is interacting, such as an automated teller machine (ATM). Stress threshold levels and contingent actions may be stored in the person's personal device or in a network location associated with processing a transaction.

### BRIEF DESCRIPTION OF THE DRAWINGS

FIG. 1 is a block diagram illustrating system elements for situational access override of a financial instrument in accordance with the current disclosure;

FIG. 2 is a block diagram illustrating an alternate embodiment for implementing situational access override;

FIG. 3 is a block diagram illustrating yet another embodiment that may be used to implement situational access override; and

FIG. 4 is a flowchart of a method of initiating and ending situational access override.

The figures depict a preferred embodiment for purposes of illustration only. One skilled in the art may readily recognize from the following discussion that alternative embodiments of the structures and methods illustrated herein may be employed without departing from the principles described herein.

### DETAILED DESCRIPTION

Situational access override limits access to a financial instrument when a person or user is determined to be, or potentially to be, in duress or otherwise not able to make well-informed decisions. When such a condition is observed, steps are taken according to pre-determined rules or contingent actions to limit access to the financial instrument. The user may set up both the conditions to be monitored and the rules using a form or simply accept a default set of conditions and contingent actions. The contingent actions may instruct a transaction processor to increase risk rules used to evaluate a transaction, limit transactions to a certain amount, or block transactions entirely. The contingent actions may also include requirements for canceling the situational access override such as logging into an account, entering a clearance code, or verification by a third party.

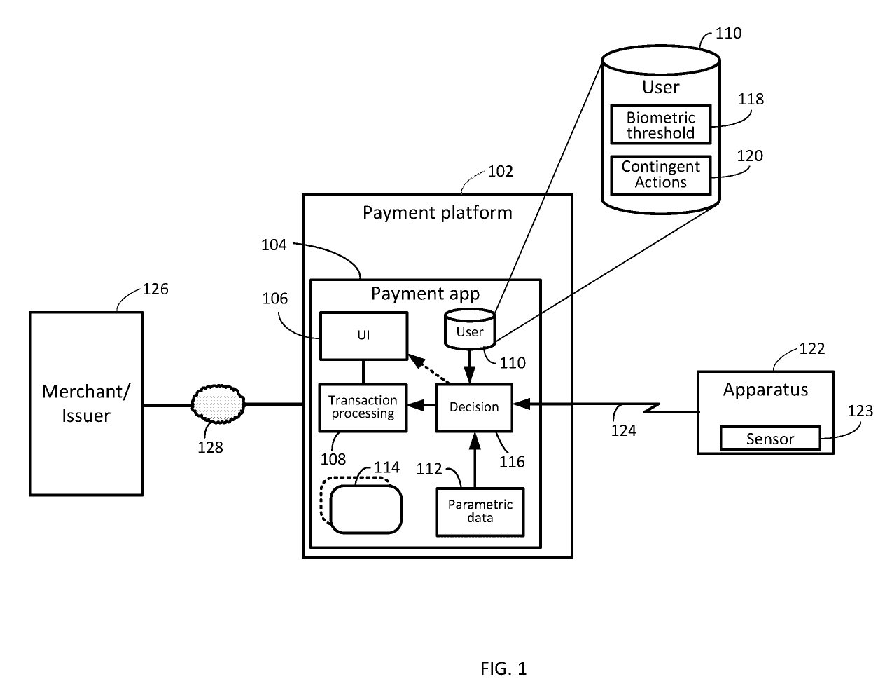

FIG. 1 is a block diagram generally illustrating one embodiment of a system for limiting access to a financial instrument during times of stress or a compromised personal situation. A payment platform 102, in this embodiment, may be a personal computer or handheld device, such as a tablet or smart phone. In other embodiments discussed below, the payment platform may be an Automated Teller Machine (ATM) or other third party device. In yet another embodiment, the payment platform may be a purpose built computing device optimized for supporting the payment platform functions.

The payment platform 102 may have a payment application 104 that is either installed and executed locally on the payment platform 102, or may be a browser running client-side code supported by a merchant or issuer 126 connected via network 128. For example, the payment application 104 may be an application or browser code provided by a merchant or issuer 126 that supports a variety of transactions specific to that merchant or issuer 126. While a merchant or issuer 126 are referred to in the following description, other entities may be represented in that role, such as a payment gateway. The role may also be represented by other product and service providers, such as utilities, travel providers, content providers, etc. While only the payment application 104 is illustrated in FIG. 1, additional applications including other payment applications may be supported simultaneously on the payment platform 102. In various embodiments, applications from multiple merchants, banks, credit card issuers, wallet applications, and the like may reside on the payment platform 102.

In various embodiments, the functions described below for situational access override may be duplicated in each of these additional applications, based on each application's particular requirements, or the hardware and software components may be shared among multiple applications using standardized application program interfaces (APIs) for initiating stress readings, invoking contingent actions, and clearing the override. In an embodiment, hardware sensors such as cameras, internal and external biometric sensors, microphones, or others, may be shared by each payment application 104 capable of supporting situational access override. The payment application 104 may include various components described below, although it will be apparent that numerous variations of the components explicitly depicted are capable of performing the activities described.

In an illustrative embodiment, the payment application 104 may include a user interface 106 and a transaction processing module 108. The user interface 106 may support functions used to select items for purchase, transfer funds between accounts, make payments, or other functions according to what is supported by the merchant or issuer 126. The user interface 106 may also support setting up situational access override including entry of stress data, contingent actions, and clearing an override.

The transaction processing module 108 may support communication with the merchant or issuer 126 and may include cryptographic processing, authentication, signing, or other functions. The transaction processing module 108 may act on data or instructions received from the decision module 116 related to situational access override, as discussed in more detail below.

A financial instrument 114 (or multiple financial instruments) may be stored with the payment application 104 and may be used to execute financial transactions, banking functions, loyalty functions, identity confirmation, etc., as supported by the payment application 104 and the associated merchant or issuer 126. In various embodiments, the financial instrument 114 may be or include a personal account number (PAN), a tokenized card number, or another account reference, such as account login credentials.

A user data module 110 may be used to store information related to situational access override, as will be discussed more below. Parametric data 112 may be information used to interpret certain biometric data including, but not limited to, time of day, ambient temperature, background noise, or data gathered via a camera. A decision module 116 is used to determine, in view of the parametric data 112, whether a condition exists for which access to the financial instrument 114 should be limited or denied using situational access override.

The user data module 110 may include threshold biometric data 118 that stores criteria used for determining whether a user associated with the user data module 110 is under sufficient duress to block or limit access to a particular financial instrument. For example, the threshold biometric data 118 may include threshold levels for pulse rate, skin moisture, and blood pressure (when suitable sensors are available). The threshold biometric data 118 may include facial recognition patterns associated with normal activity as well as voice stress data used to analyze a stress level of the user by monitoring a speech pattern of an utterance made by the user. In one embodiment, the utterance may be predetermined word or phrase, such as “don't hurt me.” The threshold biometric data 118 may include information that is not strictly related to biometrics, such as speech recognition patterns for comparison to a trigger word or phrase such as “Armageddon!” used to the invoke situational access override.

The user data module 110 may also include contingent actions 120 used to inform the decision module 116 or transaction processing module 108 as to how to handle different circumstances associated with situational access override. For example, depending on how many data points are analyzed and how much a current reading differs from a threshold value stored in the threshold biometric data 118, the contingent actions 120 may include capping the amount of a financial transaction using the financial instrument, capping a number of transactions allowed in a period of time (volume and velocity limits), denying any transaction using the financial instrument 114, or sending a message to the merchant or issuer 126 or an intermediary to place a hold on all financial instruments associated with the user.

In another embodiment, the contingent actions 120 may include sending a message to the merchant or issuer 126 to increase the risk rules used to authorize transactions. In various embodiments, the contingent action selected will remain in place until the observed condition is cleared or the override state is canceled by the user or a third party using a predetermined criteria. Storing the contingent actions 120 with the user data module 110 allows more flexible rules for situational access override, but in other embodiments, the contingent actions 120 may not be user-specific and may cover a wider range of users or payment applications. In other embodiments, the contingent actions 120 may be stored at the merchant or issuer 126, in the transaction processing module 108, or in the decision module 116. In embodiments described below, the entire user data module 110 may not reside on the payment platform at all, but rather may be stored in a wallet account or other upstream entity.

An apparatus 122 may provide a signal 124 used by the decision module 116 to determine whether to invoke situational access override. In some embodiments, the apparatus 122 may be a separate device such as a fitness monitor, smart watch, or camera while in other embodiments, the apparatus 122 may be integral to the payment platform 102 and may be or include a sensor 123 such as a camera, microphone, fingerprint scanner, or other sensor. The parametric data 112 may provide information used by the decision module 116 to help interpret information received via the apparatus 122. For example, if the ambient temperature is 95 degrees, an elevated body temperature may be discounted when evaluating whether to activate situational access override.

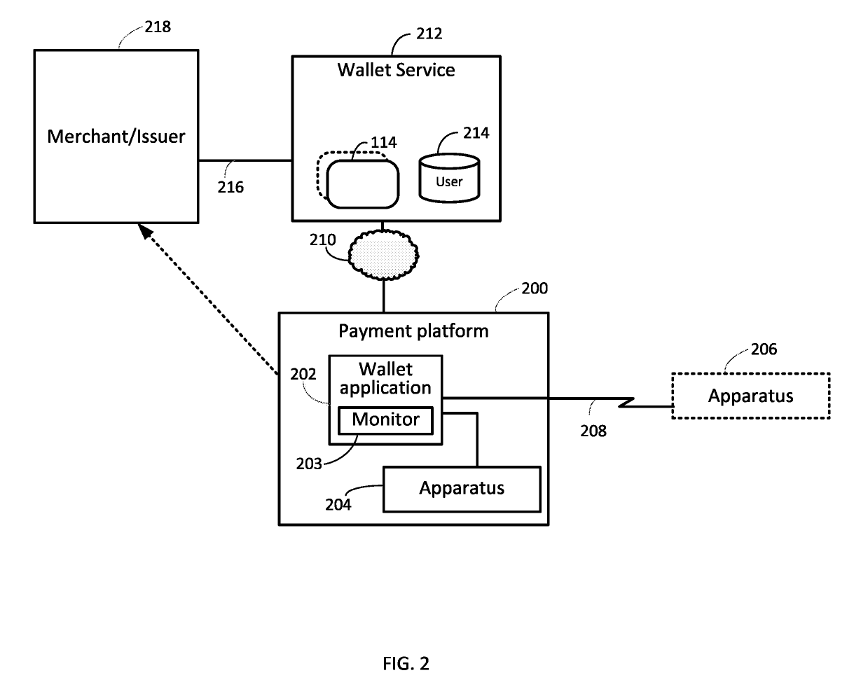

FIG. 2 is a simplified block diagram illustrating another embodiment for situational access override of a financial instrument. In this embodiment, a payment platform 200, such as a smartphone, may host a wallet application 202 that is utilized to perform a transaction via a wallet service 212. The wallet application 202 may have a monitor 203 used in conjunction with situational access override. For example, as a person (user) engages in a purchase or a cash transfer using the wallet application 202, the monitor 203 may collect biometric information from an apparatus 204. The apparatus 204 may be or include a biometric sensor, such as a fingerprint sensor or a pulse monitor, or may be a camera that takes a photograph of a user's face.

In various embodiments, collecting data from the apparatus 204 may be active or passive. That is, in one embodiment, the user may be prompted to use the apparatus 204 by placing a finger on a sensor or posing for a photograph. In another embodiment, collecting the data may be performed passively, such as taking a photograph with a front-facing camera without indicating that the camera is active.

Especially when data collection is explicitly sought, because the user may be under duress with a bad actor present, it may be desirable for the biometric processing to give an indication that the biometric screening was successful even when the transaction will ultimately be limited or denied based on the characteristics of the biometric data collected. That is, the monitor 203 may be programmed to indicate the biometric screen was successful even when either the monitor 203 or a downstream process may determine that the biometric data fails to satisfy a condition for full access to the financial instrument 114.

As discussed above, the biometric data may be data corresponding to pulse rate, blood pressure, facial stress, or a specific look, such as crossing the eyes. In other embodiments, the data collected may not be strictly biometric data but may include other explicit signals such as shaking the payment platform 200 or pressing a combination of buttons. In an alternate embodiment, the apparatus 204 may not be part of the payment platform 200 but instead may be an external apparatus 206 that communicates with the payment platform 200 via a network connection 208, such as Bluetooth®. For example, the external apparatus 206 may be a fitness tracker or smart watch capable of monitoring body conditions or even taking a photograph.

In the embodiment of FIG. 2, the wallet application 202 may pass the collected biometric data (or other indicator) to the wallet service 212 via the network 210. At the wallet service 212, stored user data 214, which may be the same as or similar to user data module 110 in FIG. 1, may be used in a comparison of the biometric data collected at the payment platform 200 to the baseline data stored with the user data 214. If the biometric data meets the criteria, the transaction may be approved and the user's financial instrument 114 is approved for use in the transaction with the merchant or issuer 218 via network 216. In other embodiments, the wallet service 212 may return a token (not depicted) for use by the wallet application 202 for normal processing with a merchant or issuer 218. In an embodiment, the token may include a ‘deny’ or ‘limit’ message along with the tokenized card number so that the merchant or issuer 218, or other processor, applies the included information when processing the transaction.

In an alternate embodiment, the payment platform 200 or the external apparatus 206 may be shaken, rotated repeatedly, or taken through some other physical maneuver or pattern to set a flag that is read by the monitor 203 to indicate that the user is under duress. The monitor 203 may be preprogrammed with one or more motions that, if performed within a certain time period of an attempted transaction, will send an override message either explicitly, or by substituting a biometric reading that is known to cause a failed condition. For example, the monitor 203 may send a pulse reading of 150 when the known threshold is 100.

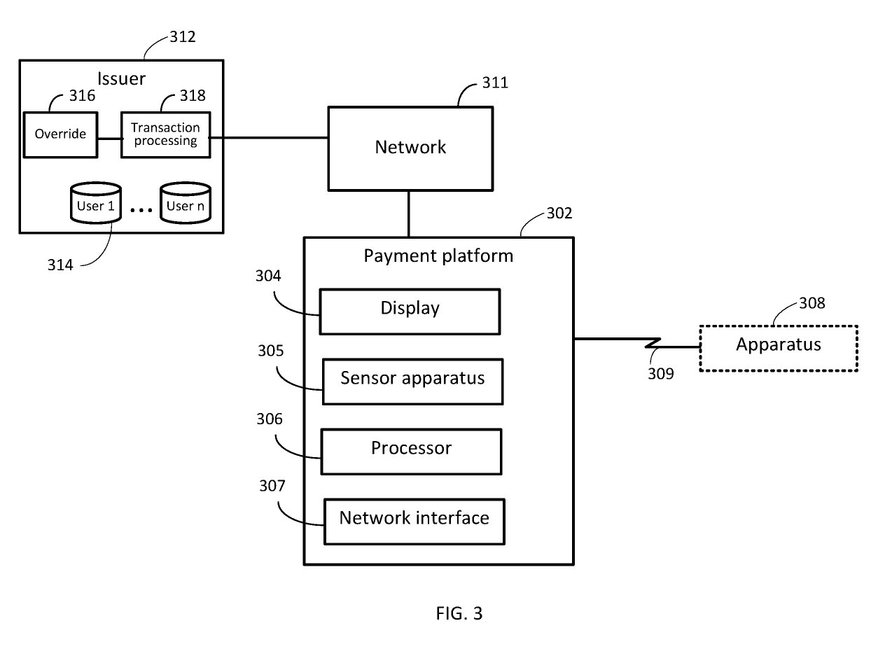

FIG. 3 is a block diagram illustrating another embodiment for implementing situational access override where the override decision making takes place at an issuer 312 or other similar authority. In this embodiment, biometric data may be collected at a payment platform 302, such as an automated teller machine (ATM). The payment platform 302 may have an integrated sensor apparatus 305 for collecting biometric data such as a palm print reader, fingerprint reader, or camera. In such an embodiment, a palm or fingerprint reader may include additional capabilities such as pulse or skin moisture sensing. In another embodiment, the payment platform 302 may be capable of collecting biometric data from a user's personal device 308, such as a smart phone or fitness tracker via a wireless connection 309.

The payment platform 302 may include a display 304 that hosts a user interface for communication with a user and a sensor apparatus 305, such as a biometric sensor that captures a stress indicator during a transaction. A processor 306 may be programmed to capture the stress indicator and send it to a downstream entity, such as an issuer 312, via a network interface 307.

As in a normal ATM transaction, the data from the payment platform 302 may be transported via a network 311 to an issuer 312 for transaction approval. (For the sake of clarity, the illustrated process is greatly simplified and does not include acquirers or other entities that may be involved in transaction processing.) In the illustrated embodiment, the data may include the stress indicator collected related to the user. The issuer 312 may then parse the data to separate the transaction information from the stress indicator. The transaction processing function 318 may begin the normal processing to determine if the transaction is capable of being executed, that is, PIN match, funds available, etc. If the transaction passes the basic tests, an override function 316 may evaluate the stress indicator received against the user data 314 stored at the issuer 312. To reiterate, the biometric data may include skin moisture, pulse, blood pressure, photographs, especial facial images, voice snippets for voice stress analysis or more.

When the biometric data comparison satisfies the conditions associated with approving a transaction, a success message is passed back to the payment platform 302 for continuing the transaction, e.g., dispensing cash. When the biometric data fails to satisfy the conditions associated with approving the transaction, a fail message may be sent to the payment platform 302 and the transaction is denied. The contents of the fail message, and ultimately, what is presented to the user on the payment platform 302 may depend on any contingent action data stored in the user data 314. In various embodiments, the fail message may be designed to discourage a bad actor from further pursuing use of that financial instrument, such as “insufficient funds” rather than a simple “error” message. In other embodiments, when funds may actually be available, the transaction may be approved at a lower amount or even the full amount if below a value set according to the contingent action data. In other embodiments, but perhaps particularly when the full or partial transaction is approved, the response message from the issuer may be routed to local authorities or at least to the location of the payment platform 302 so that staff may be alerted to the situation or additional cameras may be concentrated in that direction.

The previous embodiments should not be viewed as being limited solely to the illustrated configurations. For example, the embodiment of FIG. 1 may include a wallet platform as depicted in FIG. 2, or the embodiment of FIG. 3 may include a monitor application in the payment platform 302. The above are merely representative of other combinations of how alarm or biometric data are collected and where they are evaluated with respect to restricting financial instrument access for situational override access.

When setting conditions, the user may be able to input various biometric readings for which he or she would be considered under duress. For example, threshold values for a pulse rate, a blood pressure, a body temperature, or a skin conductivity (moisture level) may be entered by a user. These may be based on information from a fitness tracker or other health application that measures nominal and elevated levels for these values. In an embodiment, the user may reach a state of elevated levels, e.g., through exercise, and capture the readings available at that time.

In each of the embodiments described above, various processes may be used to clear the override. The override may be cleared locally at the payment platform 102 using either a code or verbal instruction entered into the payment application 104. In another case, the payment application 104 may retake the biometric readings and determine that the new biometric readings are below the threshold biometric data 118 in order to clear the override. The override may also be cleared by simply logging into an online account at a merchant or issuer 126, or wallet service 212, or in some cases, entering a code after logging into one of these accounts. In other cases, where a higher level of risk to a user may be a concern, clearing the override may require intervention by a third party as proof that the user is no longer in a high-stress state. For example, a friend or relative, bank employee, etc., may have to enter a code to clear the override, for example, by entering the code into the user's payment application 104.

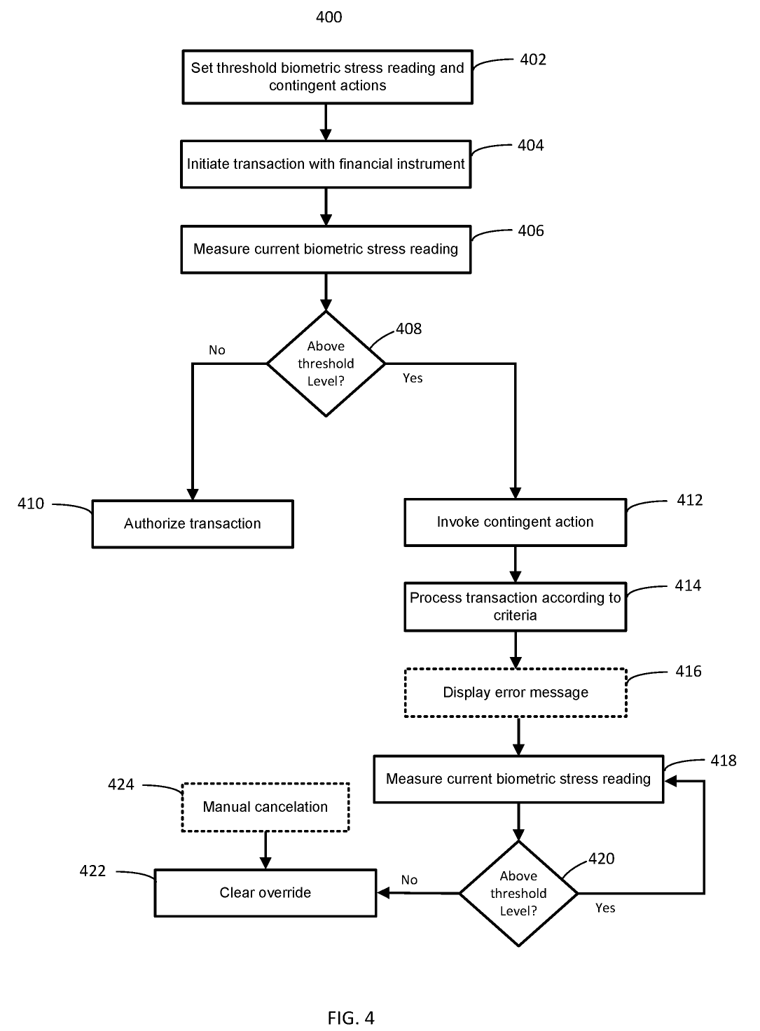

FIG. 4 is a flowchart of a method 400 of performing situational access override. At block 402, a threshold stress value (or values) may be used to determine when a transaction will be limited or denied based on corresponding values collected at the time of a transaction. Threshold stress values may be developed and stored using baseline values or measured values when the user is under stress. The baseline values may represent biometric values in normal circumstances (without undue stress) with a threshold stress value being calculated relative to these baseline values. For example, a normal pulse rate of 60 may be increased by a factor of 1.5 to give a threshold value of 90. The factor may be a default or may be taken from empirical data related to age, gender, activity level, etc. In another embodiment, the threshold values may be determined by capturing various biometric data during exercise or while watching a frightening movie and making any further adjustments as necessary to set the threshold level. In embodiments where an explicit action, such as shaking a smart phone is evaluated, a threshold value for g-force, frequency and/or duration may be set for use in later comparisons to a measured value.

Contingent actions 120 may be developed at block 402 as well. Contingent actions 120 are courses of action that are taken when one or more biometric stress values fail to satisfy its respective condition. Denial of a transaction, a limitation on an amount of a transaction, instructions to increase risk rules are all possible courses of action, among many others. In different embodiments, the courses of action may be dependent on the actual biometrics that are read and the amount by which they fail to meet the decision criteria. For example, a pulse rate 10% over the threshold value may call for an increase in risk rules, while a pulse rate 40% over the threshold value may call for blocking all transactions.

At block 404, a transaction may be initiated involving use a financial instrument 114. The transaction may be opening a payment application 104 on a payment platform such as a smart phone or may be the initiation of a transaction at an ATM. In other embodiments, the transaction being initiated may be the activation of a merchant check-out page or a payment wallet.

Following the initiation of a transaction using the financial instrument 114, execution continues at block 406 where one or more biometric stress indicators are collected. In various embodiments, the stress indicators may be personal biometric readings, such as a pulse or blood pressure, skin moisture, a voice stress analysis, a facial expression, or may be an explicit indicator, such as shaking a smart phone in a predetermined pattern, or a combination of these.

At block 408, a comparison of the stress indicator(s) may be made to corresponding threshold stress values developed at block 402. When the stress indicators do not exceed their respective threshold values, the ‘no’ branch from block 408 may be taken to block 410, and the transaction is authorized to proceed using standard processing and currently selected risk rule levels. However, when at block 408 one or more stress indicators exceed their respective values, execution may follow the ‘yes’ branch to block 412. Predetermined rules may be applied as to how many biometric values are collected and whether any single reading that exceeds its respective threshold value is enough to trigger the situational access override. In some cases, different readings may be prioritized, so that a failed blood pressure reading on its own may be enough to cause the failed test while in the absence of a blood pressure reading, both facial expression and skin moisture must be above their respective thresholds to trigger the situational access override.

At block 412, one or more contingent actions may be selected from among the stored contingent actions 120. The transaction may then be processed at block 414 according to the selected contingent action or actions. The contingent actions 120 may be stored and executed in different places as discussed above, from the local payment platform 102 to a merchant or issuer 126 or an intermediary, such as a wallet service 212. In various embodiments different combinations of execution may be used. For example, a contingent action carried out at the payment platform 102 may be to include an instruction in a payment request that raises a risk rule level or explicitly requests the transaction to be rejected by the issuer 126. Thus, the execution of the contingent action may spread among the entities involved in the transaction.

After the contingent action is completed, or as part of completing the contingent action, an error or similar message may be displayed at block 416. As discussed above, the error message may be tailored to a situation where the user may be being coerced to execute a financial transaction. For example, a simple ‘transaction not completed’ message may encourage the bad actor to try again using a different website or ATM. In contrast, an ‘insufficient funds’ or ‘account on hold’ message may discourage continued attempts to use the financial instrument 114.

At block 418, stress indicators may continue to be collected, especially so in the case where the readings are made by a separate apparatus 122 such as a fitness tracker. At block 420, if the stress indicators remain above the threshold level, execution may return to block 418. However, if the stress indicators have returned to more normal levels and are below their corresponding levels from the threshold biometric data 118, execution may continue at block 422 where any contingent actions in place are canceled and future transaction processing is allowed to continue in a normal fashion. For example, a trusted message may be sent from the payment application 104 to the merchant or issuer 126 indicated that any contingent actions in place with respect to the financial instrument should be removed and processing returned to pre-event conditions.

Alternatively, the override may canceled explicitly using any of the techniques discussed above, such as entering a code or logging into a related website to perform a specific clearing action, illustrated at block 424, with the override being cleared at block 422 as described above.

The ability to limit access to a financial instrument based on user stress indicators benefits both the user and merchants or issuers. Use of the techniques disclosed above allow the user to cooperate in a potential dangerous situation but likewise allow the user's natural reactions to being in a threatening situation to limit the user's financial exposure in such a situation, without any explicit or overt actions. The merchants and issuers are protected from fraudulent transactions perpetrated by a bad actor who is coercing a legitimate user. A technical effect of the instant disclosure is the use of biometric sensors and/or cameras to determine a state of being of the user as part of using a financial instrument in a transaction.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” or “teaching” means that a particular element, feature, structure, or characteristic described in connection with the embodiment is included in at least one embodiment. The appearances of the phrase “in some embodiments” or “teachings” in various places in the specification are not necessarily all referring to the same embodiment.

Further, the figures depict preferred embodiments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for the systems and methods described herein through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the systems and methods disclosed herein without departing from the spirit and scope defined in any appended claims.

1. A method of limiting access to a financial instrument of a person based on data collected by at least one sensor at a time of a transaction, the method comprising:
receiving, responsive to initiating a financial transaction, a stress indicator from an apparatus proximate the person;
comparing the stress indicator to a threshold value;
enabling, at a device associated with the transaction, full access to the financial instrument when the stress indicator satisfies a condition relative to the threshold value; and
disabling, at the device associated with the transaction, full access to the financial instrument when the stress indicator fails to satisfy the condition relative to the threshold value.

2. The method of claim 1, further comprising entering the threshold value.

3. The method of claim 2, wherein entering the threshold value comprises manually entering a biometric value corresponding to the threshold value.

4. The method of claim 2, wherein entering the threshold value comprises capturing a biometric reading at the apparatus during a period of stress experienced by the person.

5. The method of claim 1, wherein the stress indicator is a pulse rate of the person collected at the apparatus.

6. The method of claim 1, wherein the stress indicator is an utterance spoken by the person.

7. The method of claim 1, wherein the stress indicator is a body temperature of the person.

8. The method of claim 1, wherein the stress indicator is a shaking pattern received at the device.

9. The method of claim 1, wherein disabling full access to the financial instrument comprises denying a transaction using the financial instrument.

10. The method of claim 1, wherein disabling full access to the financial instrument comprises increasing a risk rating on a transaction using the financial instrument.

11. The method of claim 1, wherein disabling full access to the financial instrument comprises setting a maximum transaction amount for a transaction using the financial instrument.

12. The method of claim 1, further comprising restoring full access to the financial instrument responsive to a clearance code received at the device.

13. The method of claim 12, wherein the clearance code is one of a code received from the person and receiving a subsequent stress indicator that satisfies the condition relative to the threshold value.

14. The method of claim 13, further comprising periodically receiving a plurality of stress indicators to evaluate whether a latest of the plurality of stress indicators satisfies the condition relative to the threshold value.

15. A method of managing access to a financial instrument based on a sensed condition, the method comprising:
receiving the sensed condition from a biometric sensor associated with a person having access to the financial instrument;
comparing the sensed condition to a threshold value; and
limiting access to the financial instrument when the sensed condition fails to satisfy a requirement relative to the threshold value.

16. A machine for accessing funds from a financial instrument comprising:
a display hosting a user interface;
a network interface that communicates with an entity that stores at least one threshold stress value pertaining to a person;
a biometric sensor that captures a stress indicator associated with the person during a transaction with the machine;
a processor programmed to use the network interface to send the stress indicator to the entity; and
the processor further programmed to present a message on the display denying access to the financial instrument when the entity determines that the stress indicator fails to satisfy a requirement relative to the at least one threshold stress value pertaining to the person stored at the entity.

17. The machine of claim 16, wherein the biometric sensor is a sensor that detects one of a skin moisture and a pulse.

18. The machine of claim 16, wherein the biometric sensor is a camera that sends an image of the person to the entity for analysis relative to the at least one threshold stress value.

19. The machine of claim 16, wherein the message presented on the display indicates insufficient funds in the financial instrument responsive to the stress indicator failing to satisfy the requirement.

20. The machine of claim 16, wherein the message presented on the display indicates a hold on the financial instrument responsive to the stress indicator failing to satisfy the requirement.
